(19) United States
(12) Patent Application Publication
(10) Pub. No.: US 2026/0229822 A1
(43) Pub. Date: Aug. 6, 2026

(54) RUGGED PLUG, RUGGED SOCKET AND OPERATING METHOD THEREOF

(71) Applicant: Getac Technology Corporation, New Taipei City (TW)

(72) Inventor: Hsiu-Yu KUO, Taipei City (TW)

(21) Appl. No.: 19/632,583

(22) Filed: Mar. 30, 2026

Related U.S. Application Data
(63) Continuation-in-part of application No. 19/001,669, filed on Dec. 26, 2024.
Application No. 19/001,669 is a continuation of application No. 18/098,051, filed on Jan. 17, 2023, now Pat. No. 12,218,460.
(60) Provisional application No. 63/931,728, filed on Dec. 5, 2025.
(60) Provisional application No. 63/388,980, filed on Jul. 13, 2022.

(51) Int. Cl. H01R 13/633; H01R 13/627; H01R 24/60

(52) U.S. Cl. CPC H01R 13/633; H01R 13/6273; H01R 24/60

(57) ABSTRACT

A rugged plug has a connector, an elastic inner sheath and a slidable rigid sheath. The connector has a coupling end. The elastic inner sheath sleeves over the connector, and the elastic inner sheath includes an elastic arm and a stop block. In addition, a hook laterally protrudes from one side of the elastic arm, the hook and the stop block respectively protrude from outer surfaces of the elastic inner sheath, a tip of the hook includes a curved surface, and a boss is formed on the elastic arm and the boss includes a pressed slope. The slidable rigid sheath movably sleeves over the elastic inner sheath and covers the pressed slope. The hook is located outside the slidable rigid sheath. The slidable rigid sheath includes an actuating curved surface abutting against the boss and is limited between the stop block and the boss.

### CROSS-REFERENCE TO RELATED APPLICATIONS

The application claims priority to U.S. Provisional Application No. 63/931,728, filed on Dec. 05, 2025, the disclosure of which is hereby incorporated by reference herein in its entirety. This application is a Continuation-in-part of U.S. Application Serial Number 19/001,669, filed on Dec. 26, 2024, which is a continuation of U.S. Non-Provisional Application No. 18/098,051, filed on January 17, 2023, now granted as U.S. Pat. No. US 12,218,460, issued on Feb. 04, 2025, which claims priority to U.S. Provisional Application No. 63/388,980, filed on July 13, 2022. The disclosures of U.S. Application Serial Number 19/001,669, U.S. Non-Provisional Application No. 18/098,051, and U.S. Provisional Application No. 63/388,980 are hereby incorporated by reference herein in their entireties.

### BACKGROUND OF THE INVENTION

### FIELD OF THE INVENTION

The disclosure relates to a rugged plug, and more particularly, to a rugged plug that can be easily unplugged and an operating method thereof.

### DESCRIPTION OF THE PRIOR ART

A rugged plug is a connector device having a rugged structure. When a connector of the rugged plug is in a connected state, the rugged structure is capable of withstanding external forces to prevent the connector from falling off or from being damaged. However, a common rugged plug is locked by a structure such as a latch or a hook and hence prevented from falling. Thus, more complicated actions are also needed to release and unplug the rugged plug. As a result, it is usually not easy to plug and unplug a common rugged plug.

In view of the above, on the basis of extensive development with the practice of theories, the applicant has provided an invention in aim of improving and resolving the above issues above.

### SUMMARY OF THE INVENTION

The disclosure is directed to a rugged plug that can be easily unplugged and an operating method thereof.

The disclosure is directed to a rugged plug having a connector, an elastic inner sheath and a slidable rigid sheath. The connector has a coupling end, the elastic inner sheath is sleeved over the connector, and the elastic inner sheath includes an elastic arm and a stop block. A hook laterally protrudes from one side of the elastic arm, the hook and the stop block respectively protrude from outer surfaces of the elastic inner sheath, and a tip of the hook is a curved surface. In addition, a boss is formed on the elastic arm and the boss has a pressed slope. The slidable rigid sheath is movably sleeved over the elastic inner sheath, the slidable rigid sheath covers the pressed slope, and the hook is located outside the slidable rigid sheath. In addition, the slidable rigid sheath includes an actuating curved surface abutting against the boss, and the slidable rigid sheath being is limited between the stop block and the boss. When the slidable rigid sheath is moved in a direction away from the hook, the actuating curved surface applies a force to the boss of the elastic arm so as to retract the hook inward.

In some embodiments of the disclosure, the coupling end of the elastic inner sheath includes two U-shaped lips and two notches, and the two notches are vertically aligned and vertically separate ends of the two U-shaped lips.

In some embodiments of the disclosure, the connector includes a tongue, and the tongue includes a contact section.

In some embodiments of the disclosure, the connector is in a USB Type-A plug specification, a USB Type-A receptacle specification, a USB Type-B plug specification, a USB Type-B receptacle specification, a USB Type-C plug specification, or a USB Type-C receptacle specification.

According to another aspect of the disclosure, a rugged socket for mating with the rugged plug is provided. The rugged socket includes a rigid housing, two U-shaped lips and a mating connector. The two U-shaped lips are formed at a front portion of the rigid housing and the mating connector is disposed within the rigid housing. In addition, the two U-shaped lips surround the mating connector.

In some embodiments of the disclosure, the rugged socket further includes two stop slots respectively formed at two opposite lateral sides of the rigid housing, the two stop slots horizontally separating ends of the two U-shaped lips and two hook holes formed in the two U-shaped lips.

In some embodiments of the disclosure, the rugged socket further includes two vertical ribs respectively disposed at top and bottom sides of the mating connector. In addition, the two notches at the coupling end of the elastic inner sheath respectively correspond to the two vertical ribs, and when the connector engages with the mating connector, the two notches are aligned with the two vertical ribs so that the vertical ribs enter and abut against the two notches.

In some embodiments of the disclosure, the mating connector includes a corresponding contact section, and when the connector engages with the mating connector, the contact section of the connector and the corresponding contact section of the mating connector physically contact each other to form an electrical connection, and vertical projections of the contact section and the corresponding contact section overlap with vertical projections of the hook and the hook hole.

In some embodiments of the disclosure, the rugged socket further includes two wings disposed at two opposite outer sides of the mating connector and spaced from the mating connector by two wing gaps. In addition, inner sides of the two U-shaped lips of the rugged plug include two recesses configured to accommodate the two wings.

In some embodiments of the disclosure, when the connector engages with the mating connector, a periphery of the coupling end of the connector is inserted into the two wing gaps, such that the periphery of the coupling end is positioned between a front section of the mating connector and the two wings.

In some embodiments of the disclosure, the rugged socket further includes two hollow areas respectively formed between two top ends of the two wings and between two bottom ends of the two wings. In addition, when the connector engages with the mating connector, a top edge and a bottom edge of the connector are respectively exposed to the two hollow areas.

In some embodiments of the disclosure, the rugged socket further includes a waterproof ring disposed in the rugged socket or the rugged plug to enhance waterproof performance between the rugged socket and the rugged plug.

According to further another aspect of the disclosure, an operating method of a rugged plug is provided. The operating method includes providing a rugged socket and a rugged plug plugged into the rugged socket, the rugged plug including an elastic inner sheath and a slidable rigid sheath movably sleeved over the elastic inner sheath, the elastic inner sheath including an elastic arm and a stop block, a hook laterally protruding from the elastic arm, the hook and the stop block protruding from side surfaces of the elastic inner sheath, and a tip of the hook being a curved surface, the hook being engaged with the rugged socket, the elastic arm forming a boss, and the slidable rigid sheath including an actuating curved surface abutting against the boss; moving the slidable rigid sheath in a direction away from the hook, such that the actuating curved surface applies a force to the boss of the elastic arm to cause the hook to retract inward; and moving the slidable rigid sheath in a direction toward the rugged socket, such that the slidable rigid sheath pushes the stop block of the elastic inner sheath, and after the hook abuts against the rugged socket, the hook retracts inward under a reaction force so as to allow the hook to engage with the rugged socket.

In some embodiments of the disclosure, the rugged socket includes a rigid housing, two U-shaped lips and a mating connector. The two U-shaped lips are formed at a front portion of the rigid housing, and the two U-shaped lips respectively include hook holes. The mating connector is disposed within the rigid housing, and the two U-shaped lips surround the mating connector.

In some embodiments of the disclosure, when the slidable rigid sheath is moved toward the rugged socket, the slidable rigid sheath pushes the stop block of the elastic inner sheath, such that the hook of the elastic arm abuts against the two U-shaped lips of the rugged socket and retracts inward under a reaction force, thereby allowing the hook to enter and engage with the hook holes.

In some embodiments of the disclosure, the rigid housing further includes two stop slots and two vertical ribs. The two stop slots are respectively formed at two opposite lateral sides of the rigid housing, and horizontally separate ends of the two U-shaped lips. The two vertical ribs are respectively disposed at top and bottom sides of the mating connector. In addition, the two notches at the coupling end of the elastic inner sheath correspond to the two vertical ribs, and the two notches at the coupling end of the elastic inner sheath respectively correspond to the two vertical ribs. When the connector engages with the mating connector, the two vertical ribs enter into and abut against the two notches.

In some embodiments of the disclosure, the mating connector includes a corresponding contact section and the connector includes a contact section, and when the connector engages with the mating connector, the contact section and the corresponding contact section physically contact each other to form an electrical connection, and vertical projections thereof overlap with vertical projections of the hook and the hook hole.

In some embodiments of the disclosure, the rugged socket further includes two wings disposed at two opposite outer sides of the mating connector and spaced the mating connector by two wing gaps, and inner sides of the two U-shaped lips of the rugged plug include two recesses configured to accommodate the two wings, and when the connector engages with the mating connector, a periphery of the coupling end of the connector is inserted into the two wing gaps so that the periphery of the coupling end is positioned between a front portion of the mating connector and the two wings.

In some embodiments of the disclosure, the rugged socket further includes two hollow areas respectively formed between top ends of the two wings and between bottom ends of the two wings, and when the connector engages with the mating connector, top and bottom edges of the connector are respectively exposed to the two hollow areas.

In some embodiments of the disclosure, the operating method further includes disposing a waterproof ring in the rugged socket or the rugged plug to enhance waterproof performance therebetween.

### BRIEF DESCRIPTION OF THE DRAWINGS

FIG. 1 is a perspective schematic diagram of a rugged plug plugged in a rugged socket according to an embodiment of the disclosure;

FIG. 2 is an exploded perspective schematic diagram of a rugged plug according to an embodiment of the disclosure;

FIG. 3 is a longitudinal section diagram of a rugged plug according to an embodiment of the disclosure;

FIG. 4 is a longitudinal section diagram of a rugged plug plugged in a rugged socket according to an embodiment of the disclosure;

FIGS. 5 and 6 are schematic diagrams of a rugged plug unplugged from a rugged socket according to an embodiment of the disclosure;

FIG. 7 is a perspective schematic diagram of a rugged plug plugged in a rugged socket according to another embodiment of the disclosure;

FIG. 8 is a flowchart of unplugging steps of an operating method for a rugged plug according to an embodiment of the disclosure;

FIGS. 9A, 9B, and 9C are diagrams illustrating inserting steps of the operating method of the rugged plug according to an embodiment of the disclosure;

FIG. 10 is an enlarged schematic view of the rugged socket according to an embodiment of the disclosure; and

FIG. 11 is a cross-sectional view illustrating another state of the rugged plug inserted into the rugged socket of FIG. 7.

### DETAILED DESCRIPTION OF THE EMBODIMENTS

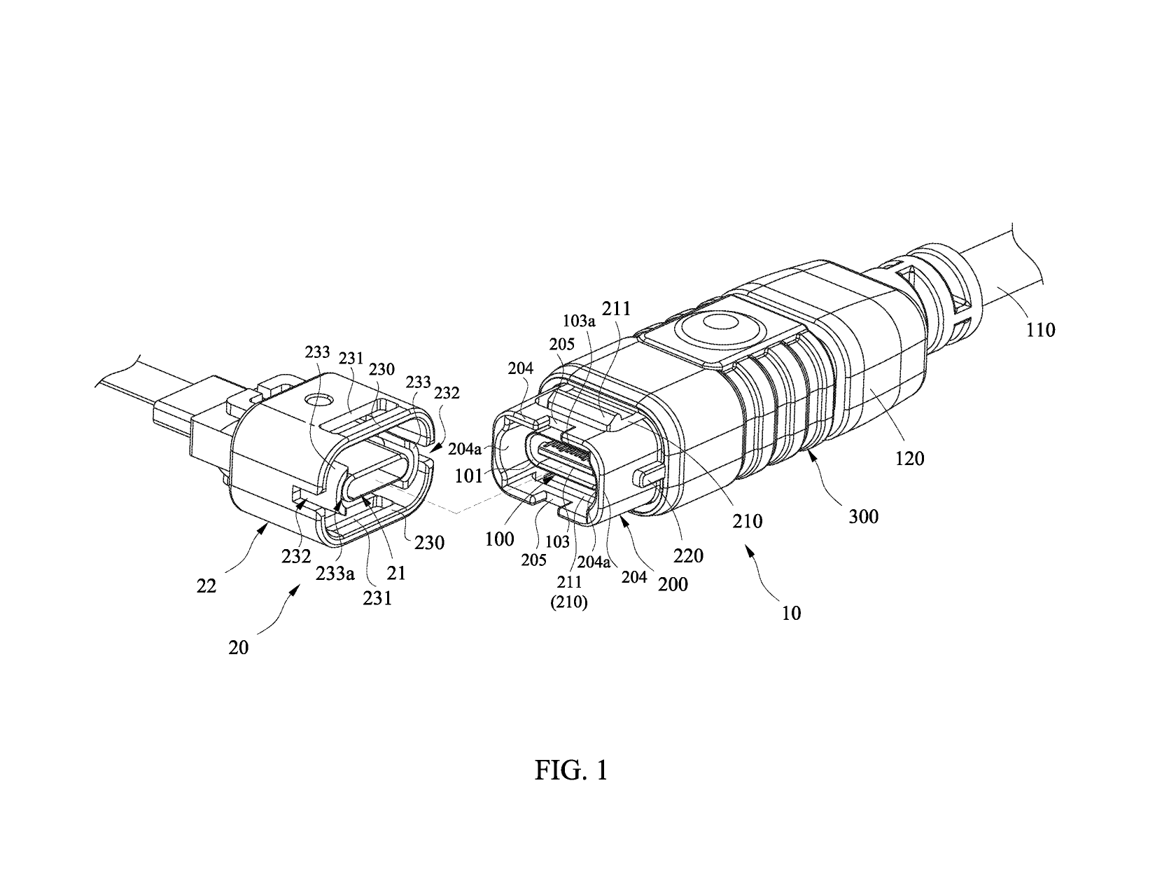

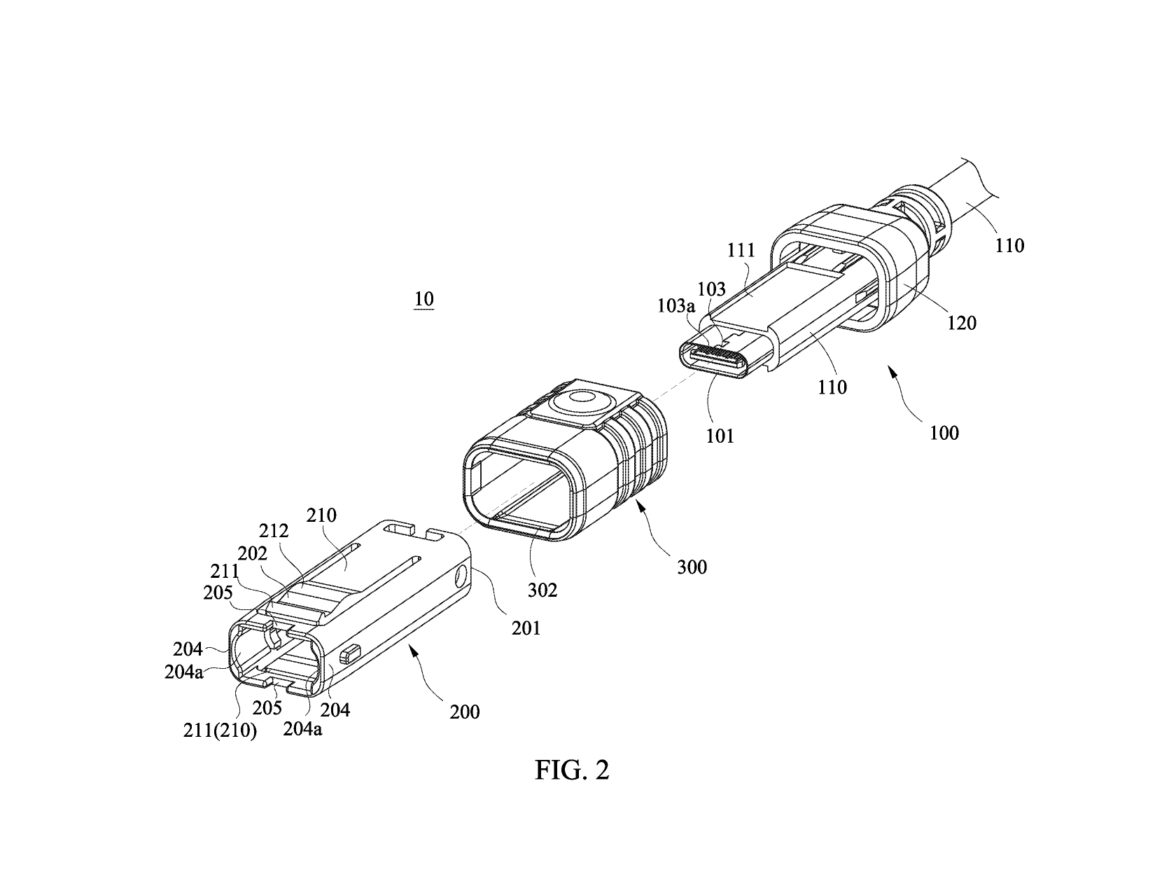

Referring to FIGS. 1 to 3, a rugged plug 10 is provided according to an embodiment of the disclosure. The rugged plug 10 includes a connector 100, an elastic inner sheath 200 and a slidable rigid sheath 300.

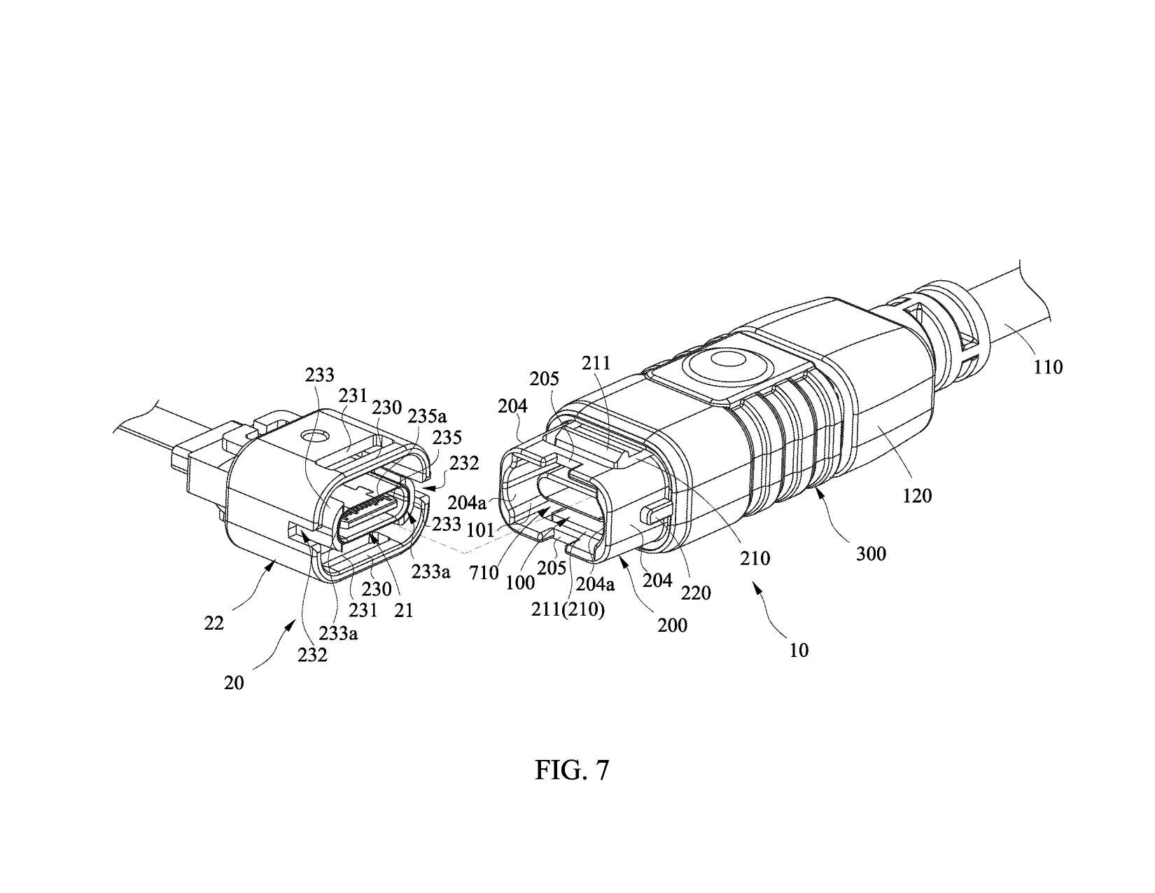

In this embodiment, the connector 100 may be in a USB type-C receptacle specification as shown in FIG. 1, or the connector 100 may be in a USB type-C plug specification as shown in FIG. 7. The present invention is applicable to all sorts of connector 100 and mating connector 21 of USB type-A, type-B, type-C or any other specifications, without departing from the spirit and scope of the present invention. The connector 100 has a coupling end 101 and a wiring end 102 opposite to the coupling end 101, and a wire 110 extends from the wiring end 102 of the connector 100. The wiring end 102 of the connector 100 is enveloped by a reinforcement sheath 120, and the wire 110 passes through the reinforcement sheath 120. The reinforcement sheath 120 is capable of reinforcing the structural strength of the wire 110 to prevent bending and hence breaking of the wire 110.

The slidable rigid sheath 300 and the elastic inner sheath 200 are made of different stainless steel materials, such that the slidable rigid sheath 300 has a rigidity higher than that of the elastic inner sheath 200, and the elastic inner sheath 200 is elastically deformable relative to the slidable rigid sheath 300. In this embodiment, the elastic inner sheath 200 is, for example, a cylinder made of 17-4PH stainless steel and has two open ends. The elastic inner sheath 200 sleeves the connector 100. One end of the inner sheath is disposed corresponding to the wiring end 102 of the connector 100 and a port 201 is provided on that end. The port 201 packs against the wire 110, and the reinforcement sheath 120 envelops the port 201 of the elastic inner sheath 200. An elastic arm 210 is provided on at least one side of the elastic inner sheath 200. However, the disclosure does not specifically define the number of the elastic arm 210; for example, in this embodiment, a pair of elastic arms 210 are disposed correspondingly on two opposite sides of the elastic inner sheath 200. In this embodiment, each elastic arm 210 extends from the wiring end 102 of the connector 100 toward the coupling end 101 of the connector 100, such that an end of each elastic arm 210 is disposed correspondingly to the coupling end 101 of the mating connector 21. However, the disclosure is not limited to the example above, and each elastic arm 210 may also be disposed in a configuration reverse to the above. A hook 211 is protruded from one lateral side of each elastic arm 210. Each hook 211 protrudes from an outer wall of the elastic inner sheath 200, and a tip of each hook 211 is a curved surface. When each elastic arm 210 receives a force and is biased toward into elastic inner sheath 200, the hook 211 can thus recede toward into the elastic inner sheath 200. A pressed slope 202 is defined on each elastic arm 210, and a direction 202n normal to each pressed slope 202 is biased toward the coupling end 101 of the connector 100. In this embodiment, a boss 212 is protruded from the side of the hook 211 of the each elastic arm 210, and the pressed slope 202 is formed on the boss 212. A yielding recess 111 corresponding to each elastic arm 210 is provided on an outer wall of the wire 110, and each elastic arm 210 is capable of being biased and receded in each corresponding yielding recess 111 when biased toward into the elastic inner sheath 200 by a force received.

The elastic inner sheath 200 includes two U-shaped lips 204 defined at a front portion of the elastic inner sheath 200. In addition, two notches 205 are respectively defined at the front portion of the elastic inner sheath 200. Preferably, the two notches 205 vertically separate the ends of the two U-shaped lips 204 respectively, that is to say, the two notches 205 vertically separate the ends of the right and left U-shaped lips 204 respectively.

The slidable rigid sheath 300 is, for example, a cylinder made of 316 stainless steel and having two open ends, and may movably sleeve the elastic inner sheath 200. At least one stop block 220 is protruded from the outer wall of the elastic inner sheath 200, and the stop block 220 and the reinforcement sheath 120 respectively correspond to two ends of a stroke of the slidable rigid sheath 300 so as to prevent the slidable rigid sheath 300 from falling off. The slidable rigid sheath 300 covers the pressed slope 202, and the hook 211 is located outside the slidable rigid sheath 300. The slidable rigid sheath 300 has an actuating curved surface 302, and the actuating curved surface 302 abuts against the pressed slope 202. In this embodiment, the actuating curved surface 302 may be a surface abutting against the pressed slope 202; however, the disclosure is not limited to the above example. For example, the actuating curved surface 302 may also be in a form of a protrusion abutting against the pressed slope 202.

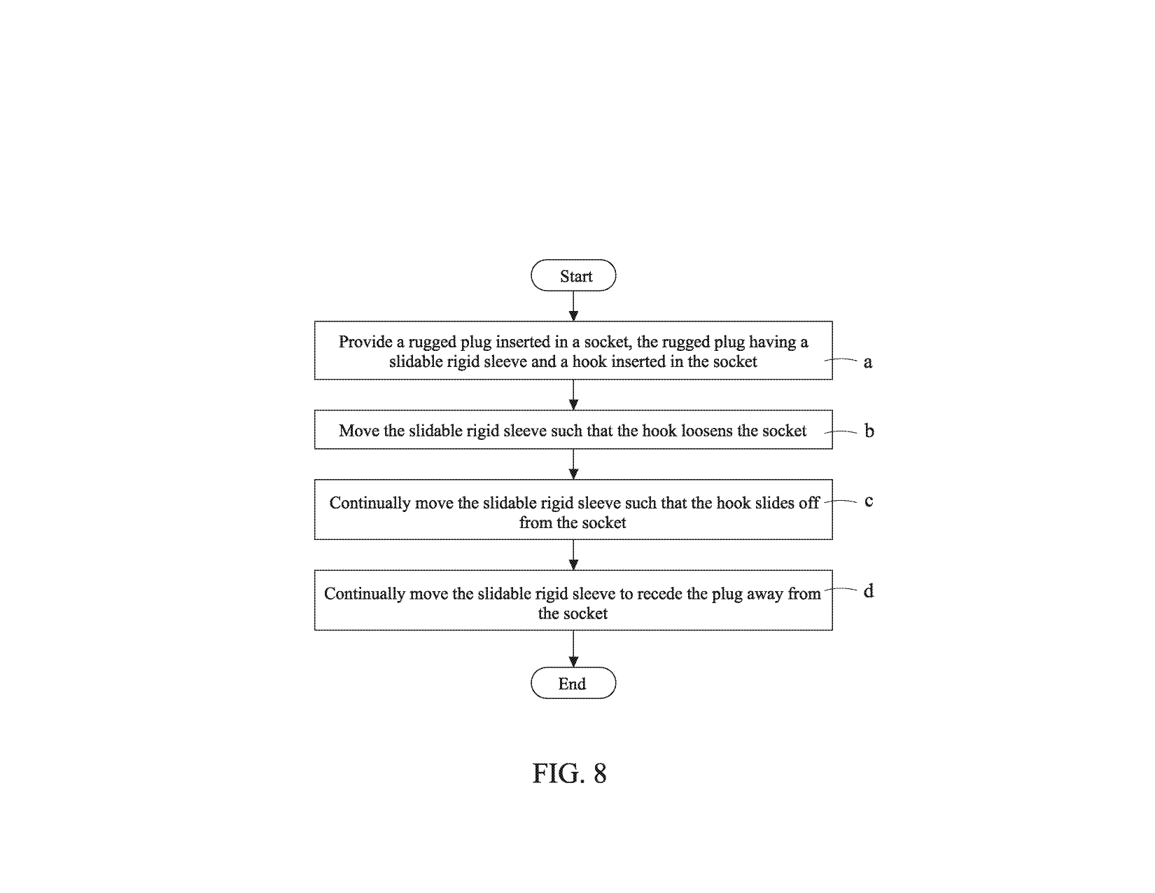

Referring to FIGS. 1 and 8, an operating method applied to the above rugged plug 10 is further provided according to an embodiment of the disclosure. The operating method includes the following steps.

Referring FIGS. 1, 4 and 8, in step a, a rugged socket 20 and the rugged plug 10 are provided, wherein the rugged plug 10 is configured to plug in the rugged socket 20. As described above, the rugged plug 10 has an elastic inner sheath 200 and a slidable rigid sheath 300. The slidable rigid sheath 300 movably sleeves the elastic inner sheath 200, and the elastic inner sheath 200 is made of, for example, 17-4PH stainless steel. The slidable rigid sheath 300 and the elastic inner sheath 200 are made of different stainless steel materials. In this embodiment, the slidable rigid sheath 300 is made of, for example, 316L stainless steel. The rugged socket 20 includes a rigid housing 22, and the slidable rigid sheath 300 and the rigid housing 22 may be made of the same stainless steel material. Simultaneously referring to FIG. 10, the rugged socket 20 has two U-shaped lips 230 defined at a front portion of the rigid housing 22. The two U-shaped lips 230 jointly surround the mating connector 21, preferably located at the top and the bottom of the mating connector 21. In addition, two stop slots 232 are respectively defined at the two opposite lateral sides of the rigid housing 22 of the mating connector 21, and in the meanwhile the two stop slots 232 horizontally separate the ends of the two U-shaped lips 230 respectively, that is to say, the two stop slots 232 horizontally separate the ends of the top and bottom U-shaped lips 230. At the deeper section of the wings 233 inside rigid housing 22 of the rugged socket 20, two opposite walls 237 respectively connect the wings 233 to form a four-wall-shaped tunnel 238. In addition, tunnel 238 allows the mating connector 21 to penetrate therethrough, and also allows connector 100 to insert between the mating connector 21 and the tunnel 238.

The elastic inner sheath 200 has an elastic arm 210, which is defined with a hook 211 protruded from one lateral side of the elastic arm 210. The hook 211 protrudes from the side of the elastic inner sheath 200, and a tip of the hook 211 is a curved surface. When the rugged plug 10 is plugged in the rugged socket 20, the elastic inner sheath 200 is plugged in the rigid housing 22, and the hook 211 is inserted in the rigid housing 22 and is connected at the rigid housing 22 of the rugged socket 20.

A pressed slope 202 is defined on the elastic arm 210, and a direction normal to the pressed slope 202 is biased toward the rugged socket 20. The slidable rigid sheath 300 has an actuating curved surface 302, and the actuating curved surface 302 abuts against the pressed slope 202. The rugged plug 10 includes a connector 100 inserted in the elastic inner sheath 200, and the rugged socket 20 includes a mating connector 21 inserted in the rigid housing 22. When the rugged plug 10 is plugged in the rugged socket 20, the connector 100 is connected to the mating connector 21. If the connector 100 is in a USB type-C receptacle specification as shown in FIG. 1, the mating connector 21 is in a USB plug specification; if the connector 100 is in a USB type-C plug specification as shown in FIG. 7, the mating connector 21 is in a USB type-C receptacle specification.

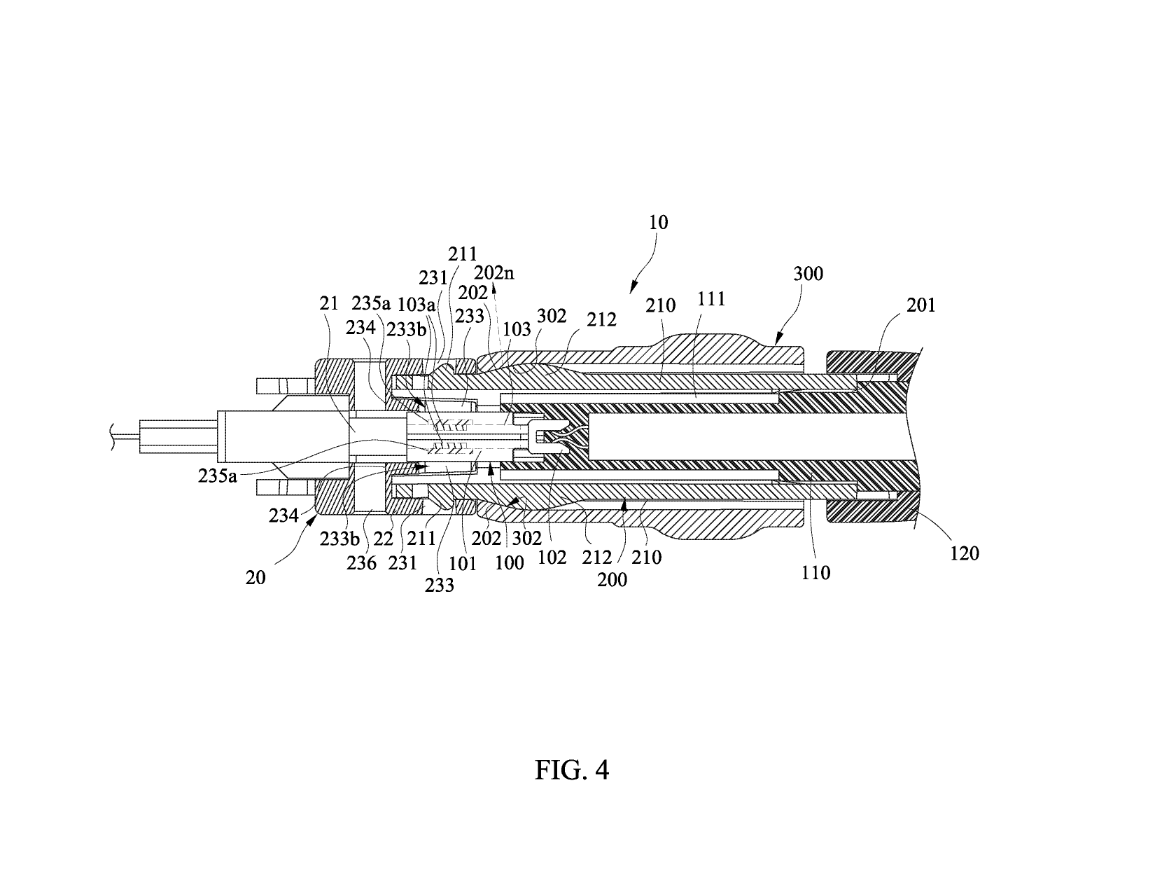

Referring to FIGS. 4, 5 and 8, in step b following step a, the slidable rigid sheath 300 is moved in a direction away from the rugged socket 20 such that the actuating curved surface 302 pushes against the pressed slope 202. Because the slidable rigid sheath 300 has a rigidity higher than that of the elastic inner sheath 200 and the elastic inner sheath 200 is elastically deformable relative to the slidable rigid sheath 300, the elastic arm 210 elastically deforms when pressed by the actuating curved surface 302 and is biased toward into the elastic inner sheath 200. The hook 211 recedes into the elastic inner sheath 200 and loosens the rugged socket 20 when the elastic arm 210 is biased toward into the elastic inner sheath 200.

In step c following step a, the slidable rigid sheath 300 is continually moved in the direction away from the rugged socket 20. At this point, the actuating curved surface 302 still presses against the pressed slope 202, and the slidable rigid sheath 300 at the same time presses the reinforcement sheath 120, and thus the rugged plug 10 in overall is pushed and moved along with the slidable rigid sheath 300. A tip of the hook 211 is a curved surface, and can thus easily slide off from the rugged socket 20 when the rugged plug 10 moves.

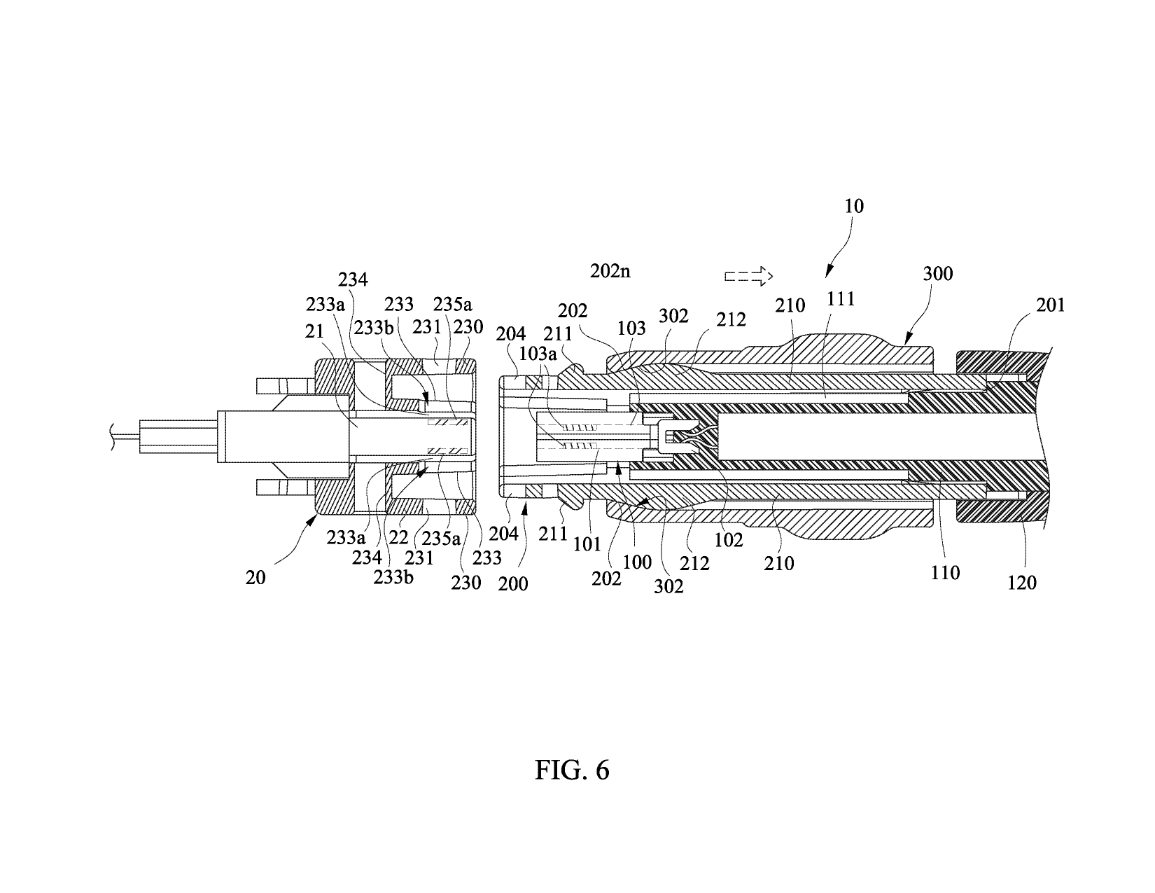

Referring to FIGS. 6 and 8, in step d following step c, the slidable rigid sheath 300 is continually moved in the direction away from the rugged socket 20, and the rugged plug 10 becomes receded from the rugged socket 20.

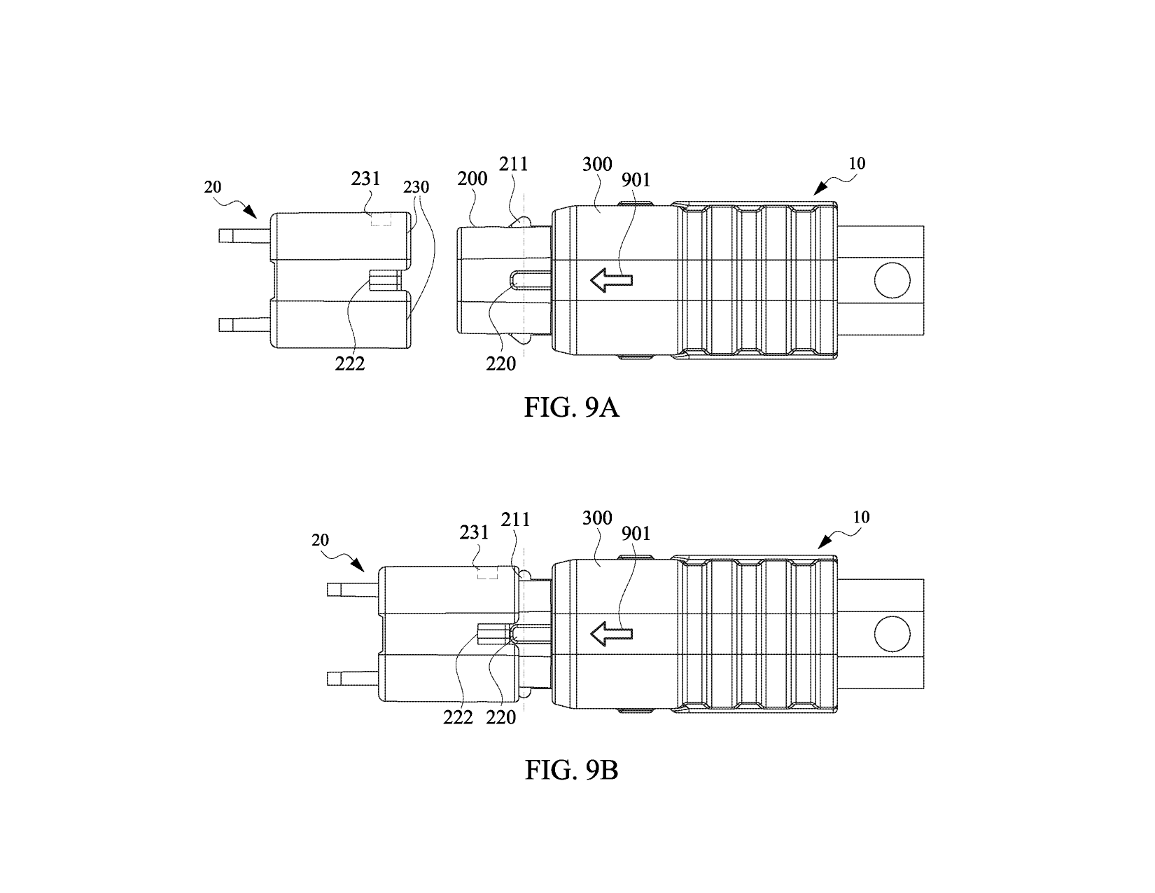

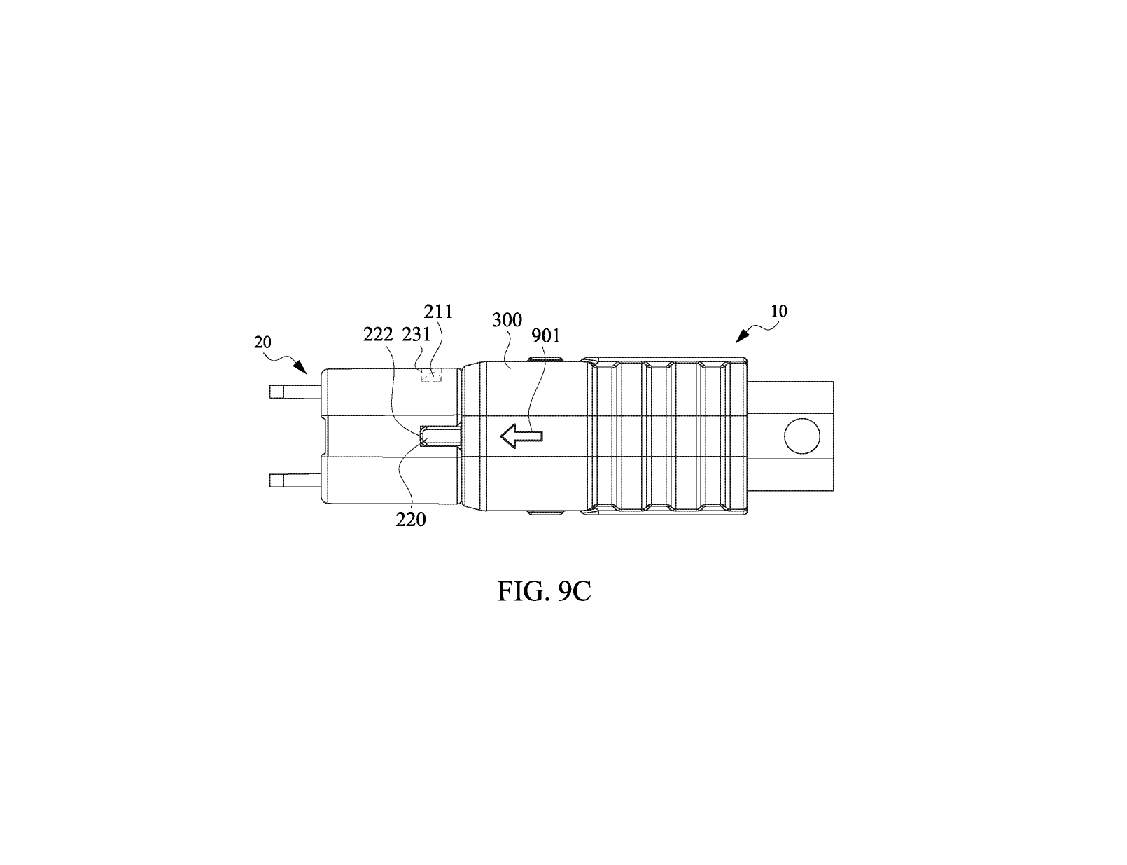

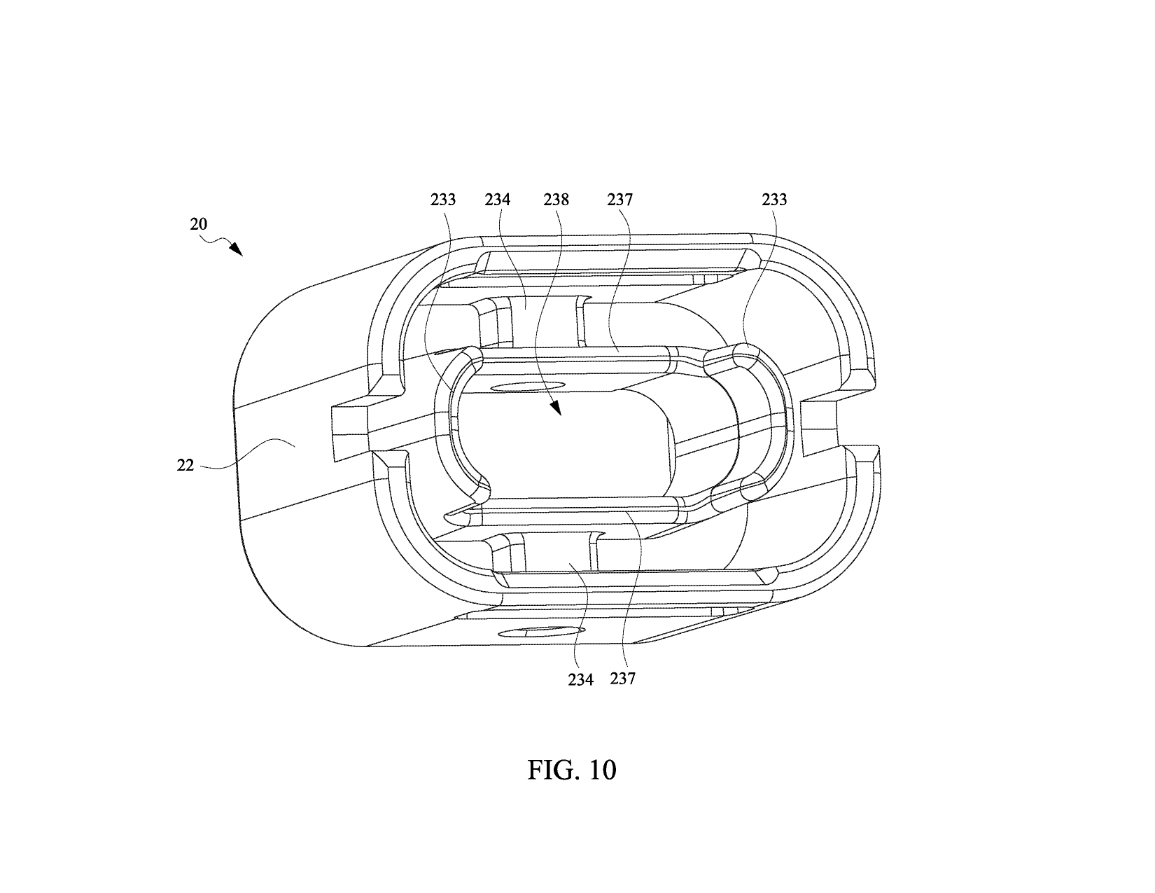

Referring to FIGS. 9A to 9C, the peak of the hook 211 falls behind the front end of stop block 220. When the hook 211 is stopped by the U-shaped lip 230, the front end of stop block 220 has entered the stop slot 232. Although the hook 211 is stopped by the U-shaped lip 230, the slidable rigid sheath 300, held by the user, still pushes stop block 220 such that the elastic inner sheath 200 and the entire rugged plug 10 keep moving forward along the arrow direction 901. When the hook 211 is pivoted and retreated, the elastic inner sheath 200 is able to move forward along the arrow direction 901, passing under the U-shaped lip 230 and inserting into rugged socket 20. In the meantime, the stop block 220 moves deeper into the stop slot 232, until most of the stop block 220 is accommodated by the stop slot 232, and the hook 211 bounces back to rest in hook hole 231.

The elastic arms 210 along with the hooks 211 may both be forced to pivot and retreat, namely the hooks 211 may move closer to the coupling end 101 of connector 100. However, in the engaging and disengaging processes, despite that the force of the user is applied on the same slidable rigid sheath 300, the elements that directly biases the elastic arms 210 and hooks 211 to pivot and retreat, are different.

In the disengaging process, the pressed slopes 202 of the elastic arms 210 on the elastic inner sheath 200 are biased by the actuating curved surface 302 of the slidable rigid sheath 300. Therefore, the slidable rigid sheath 300 directly forces hook 211 to retreat.

In the engaging process for the connector 100 and the mating connector 21 to engage with each other, the hook 211 is firstly stopped by U-shaped lip 230. Since the slidable rigid sheath 300, held by the user, still pushes stop block 220, the elastic inner sheath 200 and the entire rugged plug 10 still keep moving forward accordingly to apply more force onto the U-shaped lip 230 via the hook 211. Therefore, the reaction force from the U-shaped lip 230 directly forces hook 211 to retreat.

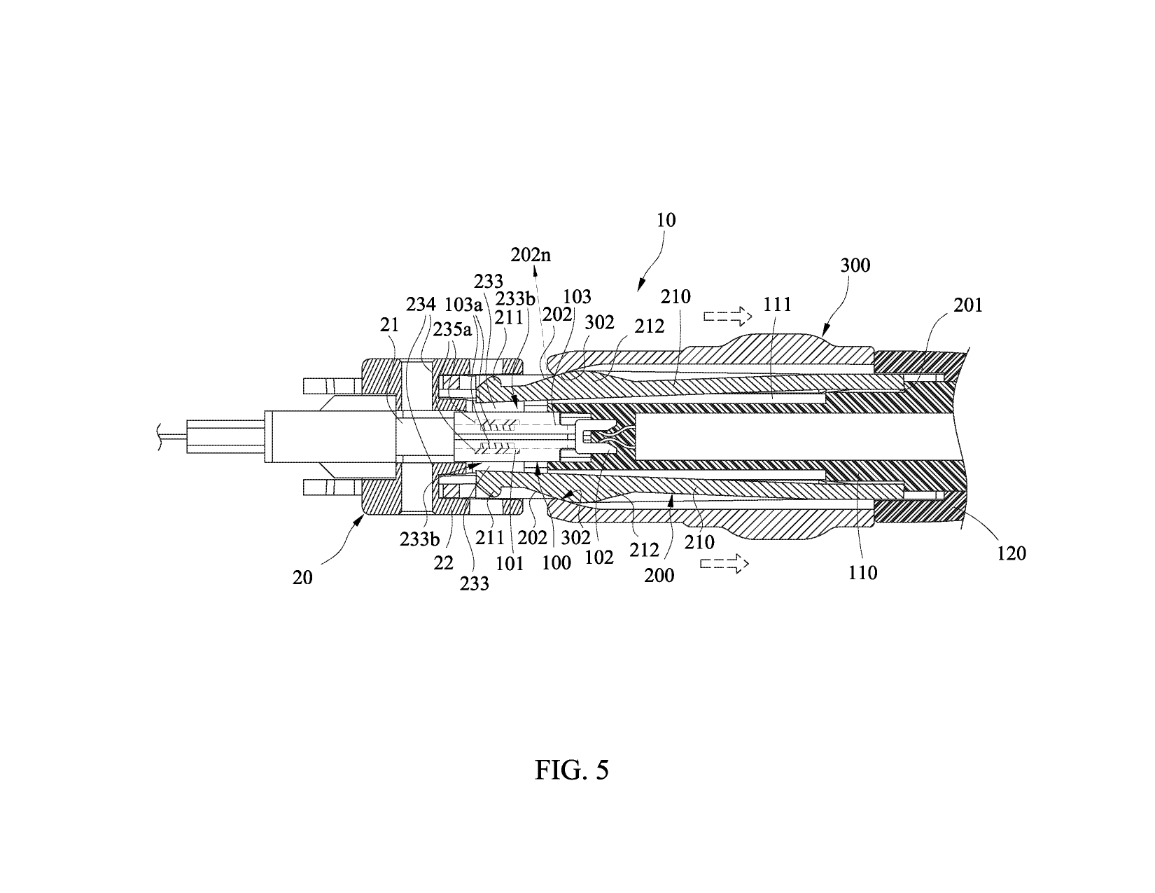

When the hooks 211 of the elastic arms 210 are both forced to retreat and move closer to the coupling end 101 of the connector 100, which shortens the distance between the two hooks 211, and allows the two opposite peaks of the hooks 211 to pass under the inner sides of the top and bottom U-shaped lips 230 and then reach the positions corresponding to the hook holes 231, see FIG. 5. At this moment, the rear portions of the hooks 211 at least partially enter into the two hollow areas 233b respectively, without interfering with the top side and bottom side of the front section of the coupling end 101 of the connector 100.

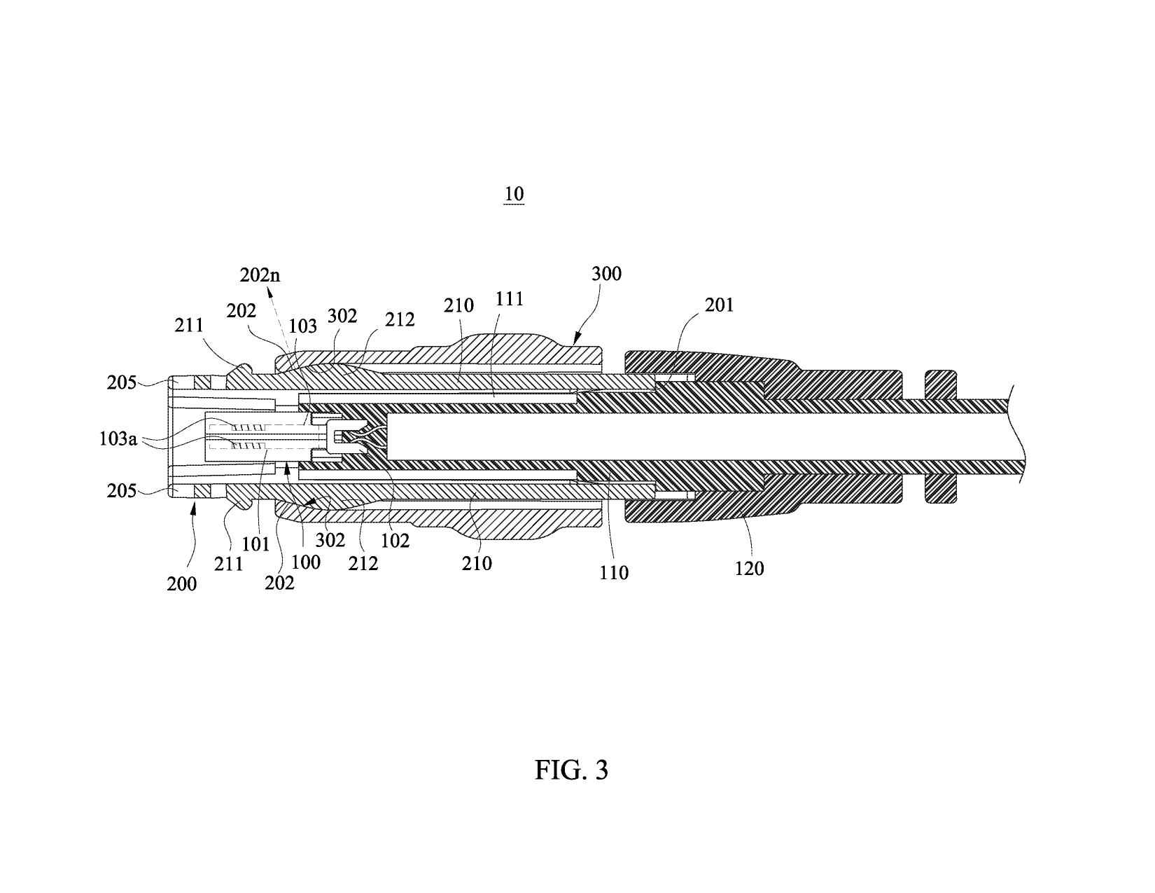

Referring to FIGS. 3 to 7, the connector 100 includes a tongue 103. The tongue 103 includes a contact section 103a. Correspondingly, the mating connector 21 includes a contact section 235a. When connector 100 and the mating connector 21 are engaged with each other, the contact section 103a and the contact section 235a are physically contact each other to form electrical connection for power and signal transmission. When the connector 100 and the mating connector 21 are engaged with each other, the vertical projections of the contact section 103a and/or the contact section 235a, overlap with the vertical projections of the hook 211 and the hook hole 231.

Referring to FIGS. 1 and 4 to 6, the two wings 233 are configured at the two opposite, lateral and outer sides of the mating connector 21, spacing away from the lateral sides of the mating connector 21 with two wing gaps 233a. During the process that the connector 100 and the mating connector 21 are engaging with each other, the peripheral of the coupling end 101 of the connector 100 is inserted into the two wing gaps 233a, such that the peripheral of the coupling end 101 is positioned between the front section of the mating connector 21 and the two wings 233. In addition, a hollow area 233b is formed between the two top ends of the two wings 233, as well as formed between the two bottom ends of the two wings 233. During the process that the connector 100 and the mating connector 21 are engaging with each other, the top side and the bottom side of the front section of the connector 100 are respectively exposed to the hollow areas 233b between the top ends and the bottom ends of the two wings 233.

Furthermore, dimples 204a are formed at the inner side of the U-shaped lips 204, and dimples 204a are configured to correspond and accommodate two wings 233 of the mating connector 21. That is to say, the dimples 204a are formed at the inner sides of the left U-shaped lip 204 and the right U-shaped lip 204, and the dimples 204a are configured to correspond and accommodate two wings 233 of the mating connector 21.

Referring to FIGS. 1, 4 to 6 and 10, two notches 205 are respectively defined at the front portion of the elastic inner sheath 200. The two notches 205 vertically separate the ends of the two right and left U-shaped lips 204 respectively. The two notches 205 align with each other vertically, which respectively correspond to two vertical ribs 234 formed at the utmost interior wall of the mating connector 21. The two vertical ribs 234 are respectively configured at the top and bottom sides of the mating connector 21. When the connector 100 and the mating connector 21 are engaged with each other, the two notches 205 are aligned with the two vertical ribs 234 of the rugged socket 20. Such design allows the two vertical ribs 234 to enter into the two notches 205 respectively or further lean against each other whenever necessary, thereby ensuring the intensity and accuracy of mutual connection.

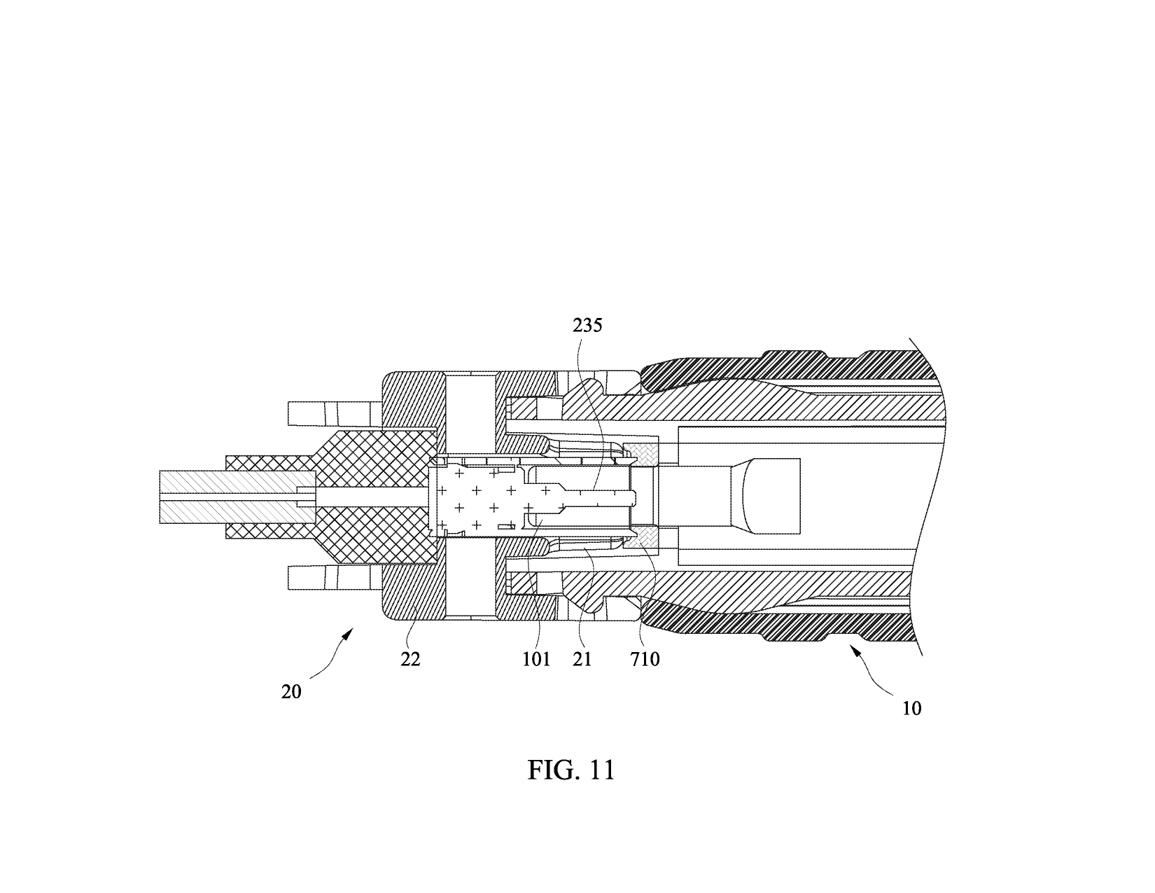

Referring to FIG. 11, between the rugged plug 10 and the rugged socket 20, a waterproof ring 710 is further provided, which is disposed in the rugged socket 20 or the rugged plug 10 to enhance the waterproof performance between the rugged socket 20 and the rugged plug 10. In some embodiments, the waterproof ring 710 may be an O-ring, such as a silicone O-ring.

In conclusion, when a user unplugs the rugged plug 10 from the rugged socket 20 by operating the rugged plug 10 of the disclosure using the foregoing operating method, the user is able to simultaneously unlock the hook 211 and recede the rugged plug 10 by merely holding and pulling the slidable rigid sheath 300 in a direction away from the rugged socket 20. In addition, when a user inserts the rugged plug 10 into the rugged socket 20, the user only needs to hold the slidable rigid sheath 300 and insert the rugged plug 10 toward the rugged socket 20. The slidable rigid sheath 300 pushes the stop block 220 of the elastic inner sheath 200, such that, after the hook 211 of the elastic arm 210 on the elastic inner sheath 200 abuts against the rugged socket 20, the hook 211 retracts inward under a reaction force, thereby allowing the hook 211 to engage with the rugged socket 20.

The description above provides merely preferred embodiments of the disclosure, and is not to be construed as limitations to the scope of the claims of the disclosure. All equivalent modifications practicing the spirit of the disclosure are to be encompassed within the scope of the disclosure.

What is claimed is:

1. A rugged plug, comprising:
a connector having a coupling end;
an elastic inner sheath sleeved over the connector, the elastic inner sheath comprising an elastic arm and a stop block, wherein a hook laterally protrudes from one side of the elastic arm, the hook and the stop block respectively protrude from outer surfaces of the elastic inner sheath, a tip of the hook comprises a curved surface, a boss is formed on the elastic arm, and the boss comprises a pressed slope; and
a slidable rigid sheath movably sleeved over the elastic inner sheath, the slidable rigid sheath covering the pressed slope, and the hook being located outside the slidable rigid sheath,
wherein the slidable rigid sheath comprises an actuating curved surface abutting against the boss, the slidable rigid sheath being limited between the stop block and the boss, and
wherein, when the slidable rigid sheath is moved in a direction away from the hook, the actuating curved surface applies a force to the boss of the elastic arm so as to retract the hook inward.

2. The rugged plug according to claim 1, wherein a coupling end of the elastic inner sheath comprises two U-shaped lips and two notches, the two notches being vertically aligned and vertically separating ends of the two U-shaped lips.

3. The rugged plug according to claim 2, wherein the connector comprises a tongue, and the tongue comprises a contact section.

4. The rugged plug according to claim 1, wherein the connector is in a universal serial bus (USB) Type-A plug specification, a USB Type-A receptacle specification, a USB Type-B plug specification, a USB Type-B receptacle specification, a USB Type-C plug specification, or a USB Type-C receptacle specification.

5. A rugged socket for mating with the rugged plug of claim 3, comprising:
a rigid housing;
two additional U-shaped lips formed at a front portion of the rigid housing; and
a mating connector disposed within the rigid housing,
wherein the two additional U-shaped lips surround the mating connector.

6. The rugged socket according to claim 5, further comprising:
two stop slots respectively formed at two opposite lateral sides of the rigid housing, the two stop slots horizontally separating ends of the two additional U-shaped lips; and
two hook holes formed in the two additional U-shaped lips.

7. The rugged socket according to claim 6, further comprising:
two vertical ribs respectively disposed at top and bottom sides of the mating connector, wherein the two notches at the coupling end of the elastic inner sheath respectively correspond to the two vertical ribs, and when the connector engages with the mating connector, the two notches are aligned with the two vertical ribs so that the two vertical ribs enter and abut against the two notches.

8. The rugged socket according to claim 7, wherein the mating connector comprises a corresponding contact section, and when the connector engages with the mating connector, the contact section of the tongue of the connector and the corresponding contact section of the mating connector physically contact each other to form an electrical connection, and vertical projections of the contact section and the corresponding contact section overlap with vertical projections of the hook and a corresponding one of the two hook holes.

9. The rugged socket according to claim 8, further comprising:
two wings disposed at two opposite outer sides of the mating connector and spaced from the mating connector by two wing gaps,
wherein inner sides of the two additional U-shaped lips formed at the front portion of the rugged plug comprise two recesses configured to accommodate the two wings.

10. The rugged socket according to claim 9, wherein when the connector engages with the mating connector, a periphery of the coupling end of the connector is inserted into the two wing gaps, such that the periphery of the coupling end is positioned between a front section of the mating connector and the two wings.

11. The rugged socket according to claim 10, further comprising:
two hollow areas respectively formed between two top ends of the two wings and between two bottom ends of the two wings,
wherein, when the connector engages with the mating connector, a top edge and a bottom edge of the connector are respectively exposed to the two hollow areas.

12. The rugged socket according to claim 5, further comprising:
a waterproof ring disposed in the rugged socket or the rugged plug between the rugged socket and the rugged plug.

13. An operating method of a rugged plug, comprising:
providing a rugged socket and a rugged plug plugged into the rugged socket, the rugged plug comprising an elastic inner sheath and a slidable rigid sheath movably sleeved over the elastic inner sheath, the elastic inner sheath comprising an elastic arm and a stop block, a hook laterally protruding from the elastic arm, the hook and the stop block protruding from side surfaces of the elastic inner sheath, and a tip of the hook being a curved surface, the hook being engaged with the rugged socket, the elastic arm forming a boss, and the slidable rigid sheath comprising an actuating curved surface abutting against the boss;
moving the slidable rigid sheath in a first direction away from the hook, such that the actuating curved surface applies a force to the boss of the elastic arm to cause the hook to retract inward; and
moving the slidable rigid sheath in a second direction toward the rugged socket, such that the slidable rigid sheath pushes the stop block of the elastic inner sheath, and after the hook abuts against the rugged socket, the hook retracts inward under a reaction force so as to allow the hook to engage with the rugged socket.

14. The operating method according to claim 13, wherein the rugged socket comprises:
a rigid housing;
two U-shaped lips formed at a front portion of the rigid housing, the two U-shaped lips respectively comprising hook holes; and
a mating connector disposed within the rigid housing,
wherein the two U-shaped lips surround the mating connector.

15. The operating method according to claim 14, wherein when the slidable rigid sheath is moved toward the rugged socket, the slidable rigid sheath pushes the stop block of the elastic inner sheath, such that the hook of the elastic arm abuts against the two U-shaped lips of the rugged socket and retracts inward under the reaction force, thereby allowing the hook to enter and engage with the hook holes.

16. The operating method according to claim 15, wherein the rigid housing further comprises:
two stop slots respectively formed at two opposite lateral sides of the rigid housing, horizontally separating ends of the two U-shaped lips; and
two vertical ribs respectively disposed at top and bottom sides of the mating connector,
wherein two notches at a coupling end of the elastic inner sheath correspond to the two vertical ribs, wherein the two notches at the coupling end of the elastic inner sheath respectively correspond to the two vertical ribs, and when a connector of the rugged plug engages with the mating connector, the two vertical ribs enter into and abut against the two notches.

17. The operating method according to claim 16, wherein the mating connector comprises a corresponding contact section and the connector comprises a contact section, and when the connector engages with the mating connector, the contact section and the corresponding contact section physically contact each other to form an electrical connection, and vertical projections of the contact section and the corresponding contact section overlap with vertical projections of the hook and a corresponding one of the hook holes.

18. The operating method according to claim 17, wherein the rugged socket further comprises:
two wings disposed at two opposite outer sides of the mating connector and spaced the mating connector by two wing gaps, and inner sides of two additional U-shaped lips of the rugged plug comprise two recesses configured to accommodate the two wings, and when the connector engages with the mating connector, a periphery of a coupling end of the connector is inserted into the two wing gaps so that the periphery of the coupling end of the connector is positioned between a front portion of the mating connector and the two wings.

19. The operating method according to claim 18, wherein the rugged socket further comprises:
two hollow areas respectively formed between top ends of the two wings and between bottom ends of the two wings, and when the connector engages with the mating connector, top and bottom edges of the connector are respectively exposed to the two hollow areas.

20. The operating method according to claim 13, further comprising:
disposing a waterproof ring in the rugged socket or the rugged plug between the rugged socket and the rugged plug .
